(19) United States
(12) Patent Application Publication
(10) Pub. No.: US 2022/0309958 A1
(43) Pub. Date: Sep. 29, 2022

(54) SPINE SURGICAL TRAINING SYSTEM

(71) Applicant: ENCORIS GROUP CORPORATION, Holland, MI (US)

(72) Inventors: Jim TenBrink, Holland, MI (US); Joel Zylstra, Hudsonville, MI (US); Harley Domasik, West Olive, MI (US)

(73) Assignee: ENCORIS GROUP CORPORATION, Holland, MI (US)

(21) Appl. No.: 17/707,828

(22) Filed: Mar. 29, 2022

Related U.S. Application Data
(60) Provisional application No. 63/167,617, filed on Mar. 29, 2021.

(51) Int. Cl. G09B 23/34

(52) U.S. Cl. CPC G09B 23/34

(57) ABSTRACT

A spinal training system includes a series of vertebrae removably held on a carrier The vertebrae may be surgically modified to allow a user to install implants such as artificial discs. The system provides a realistic experience to a user and allows a user to practice a surgical technique and evaluate the outcome of the surgery. The system simulates the compression and forces on the natural spine during use and may be modified to simulate varying anatomical defects.

### PRIORITY

The present application claims the benefit of U.S. Provisional Application Ser. No. 63/167,617, filed Mar. 29, 2021, which is herein incorporated by reference in its entirety.

### THE FIELD OF THE INVENTION

The present invention relates to a spine surgical training system. In particular, examples of the present invention relate to a system which provides educational training, surgical training, and procedural practice for the spine.

### BACKGROUND

Educational and surgical training are important to improve outcomes of patient treatment. Surgical training models may be used in an educational environment to practice procedures and familiarize students with the anatomy. Surgical training models may also be used by surgeons to practice an uncommon procedure or otherwise prepare for treatment of a patient.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a drawing which shows an isometric view of the spinal training system.

FIG. 2 is a drawing which shows an isometric view of the spinal training system.

FIG. 3 is a drawing which shows a side view of the spinal training system.

FIG. 4 is a drawing which shows a top view of the spinal training system.

FIG. 5 is a drawing which shows an end view of the spinal training system.

FIG. 6 is a drawing which shows an isometric view of the spinal training system base and carrier.

FIG. 7 is a drawing which shows an exploded view of the spinal training system carrier and vertebrae.

FIG. 8 is a drawing which shows an isometric view of the spinal training system carrier.

FIG. 9 is a drawing which shows an isometric view of the spinal training system compression bumper.

FIG. 10 is a drawing which shows an isometric view of the spinal training system tension ties.

FIG. 11 is a drawing which shows an isometric view of the spinal training system vertebrae.

FIG. 12 is a drawing which shows an end (superior) view of the spinal training system vertebrae.

FIG. 13 is a drawing which shows an end (superior) view of the spinal training system vertebrae.

FIG. 14 is a drawing which shows an end (superior) view of the spinal training system vertebrae.

FIG. 15 is a drawing which shows an end (superior) view of the spinal training system vertebrae.

FIG. 16 is a drawing which shows an isometric view of the spinal training system vertebrae.

FIG. 17 is a drawing which shows an isometric view of the spinal training system vertebrae and tension ties.

FIG. 18 is a drawing which shows a top view of the spinal training system vertebrae and tension ties.

FIG. 19 is a drawing which shows a side view of the spinal training system vertebrae and tension ties.

FIG. 20 is a drawing which shows a side view of the spinal training system carrier and vertebrae.

FIG. 21 is a drawing which shows a side view of a lumbar spinal training system.

FIG. 22 is a drawing which shows a side view of the lumbar spinal training system support frame.

FIG. 23 is a drawing which shows an exploded view of the lumbar spinal training system support frame.

FIG. 24 is a drawing which shows a cross-sectional view of the lumbar spinal training system.

FIG. 25 is a drawing which shows a cross-sectional view of the lumbar spinal training system.

FIG. 26 is a drawing which shows a side view of the lumbar spinal training system vertebrae and sacrum.

FIG. 27 is a drawing which shows an end (superior) view of a lumbar spinal training system vertebrae.

FIG. 28 is a drawing which shows a side view of the lumbar spinal training system vertebrae.

FIG. 29 is a drawing which shows an end (superior) view of a lumbar spinal training system sacrum.

FIG. 30 is a drawing which shows a side view of the lumbar spinal training system sacrum.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

As used herein, “adjacent” refers to near or close sufficient to achieve a desired effect. Although direct contact is common, adjacent can broadly allow for spaced apart features.

As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be “a little above” or “a little below” the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

A spinal training system may be used for purposes such as educational reference and surgical training. Surgeons may often desire additional experience with spine surgical procedures such as partial or total disc replacement, disc fusion, etc. In many cases, such a surgical procedure may vary according to the particular pathology of the patient and according to a particular implant used to treat the patient. Different sizes, brands, or types of spinal implants, for example, may necessitate different surgical approaches or variations to a surgical technique. A surgeon may desire to practice a surgical technique prior to surgery on a patient to familiarize themself with the technique, the particular device, and the particular pathology of the patient.

The surgical training system disclosed herein is customizable to provide patient specific pathology without the need to create expensive custom vertebrae from patient imaging data. The vertebra may be selected according to patient size and individual vertebrae may be customized to match patient physiology. The vertebrae are manufactured with a strength and density profile which is similar to human bone and may be cut and modified according to a desired surgical procedure to provide a realistic surgical experience. The vertebrae are held in compression on the surgical training system in a way that simulates the natural compression on human vertebrae due to body mass and the surrounding tissues. Accordingly, the experience of installation of an artificial disc or other prosthesis to the vertebrae is similar to the experience encountered during a patient surgery.

Vertebrae may be provided in preconfigured groups which are easily mounted onto the spinal training system. These groups of vertebrae may be held together independent of the spinal training system and easily installed onto a carrier for training use. After use, the group of vertebrae may be removed from the carrier as a unit. The group of surgically modified vertebrae, including any installed implant, may then be used to later visualize the surgical technique, modify the surgical technique, or educate others about the surgical technique.

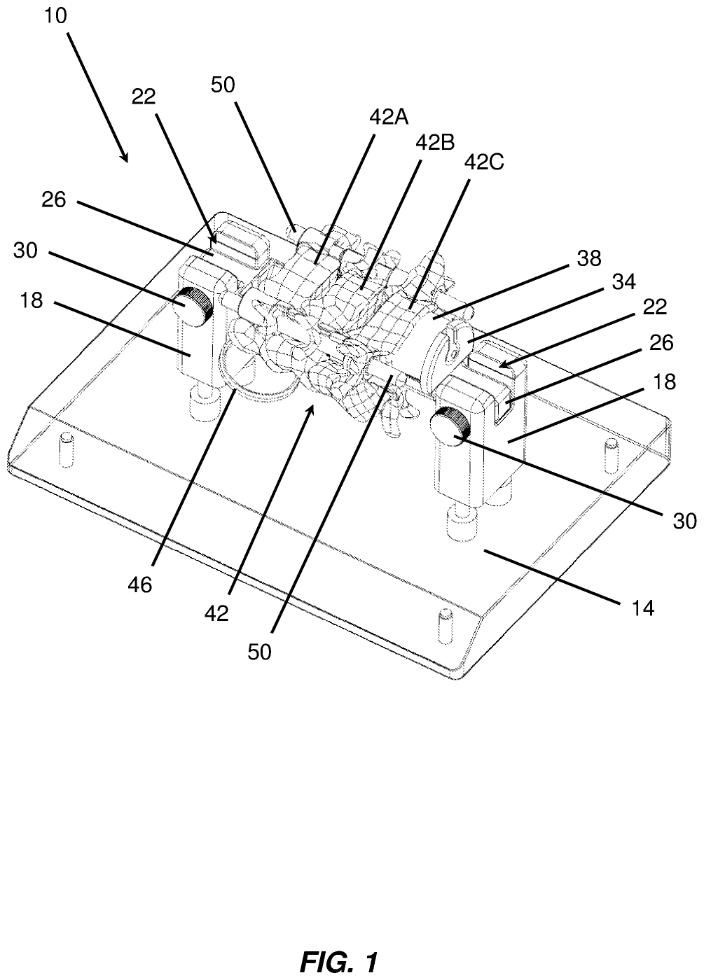

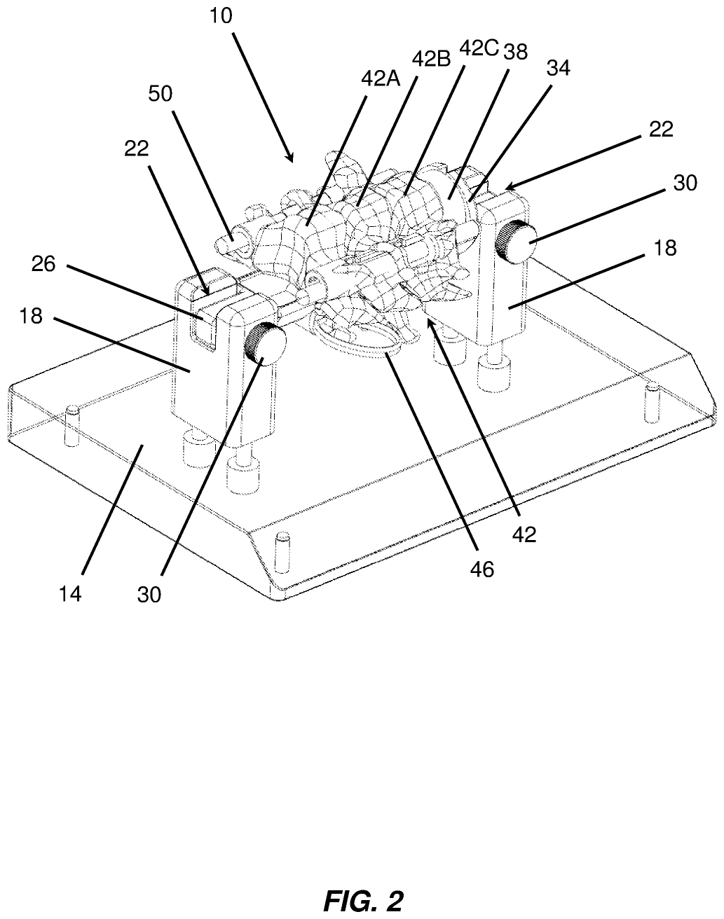

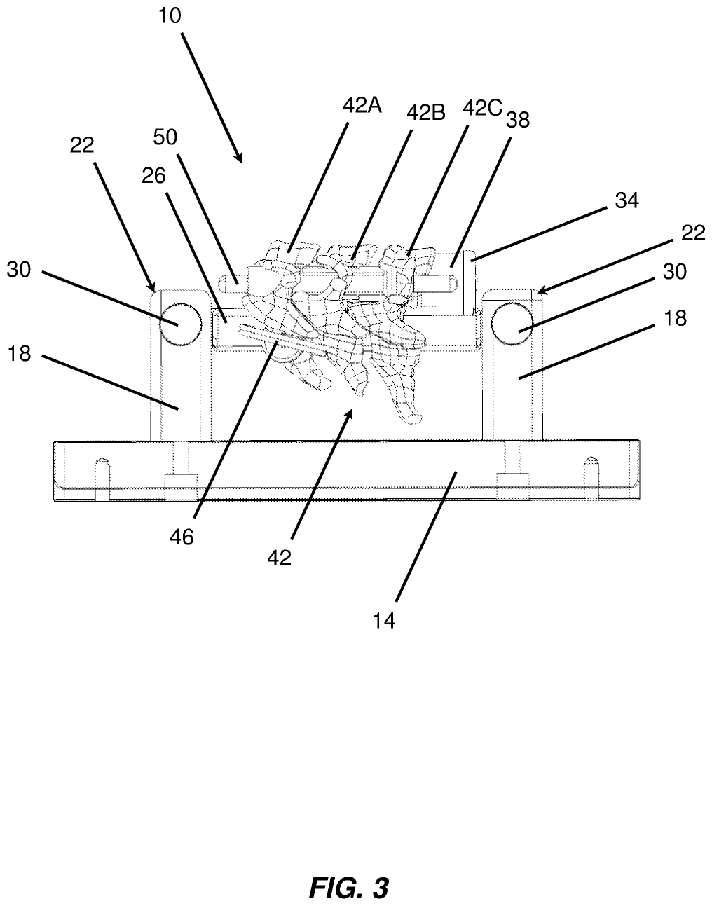

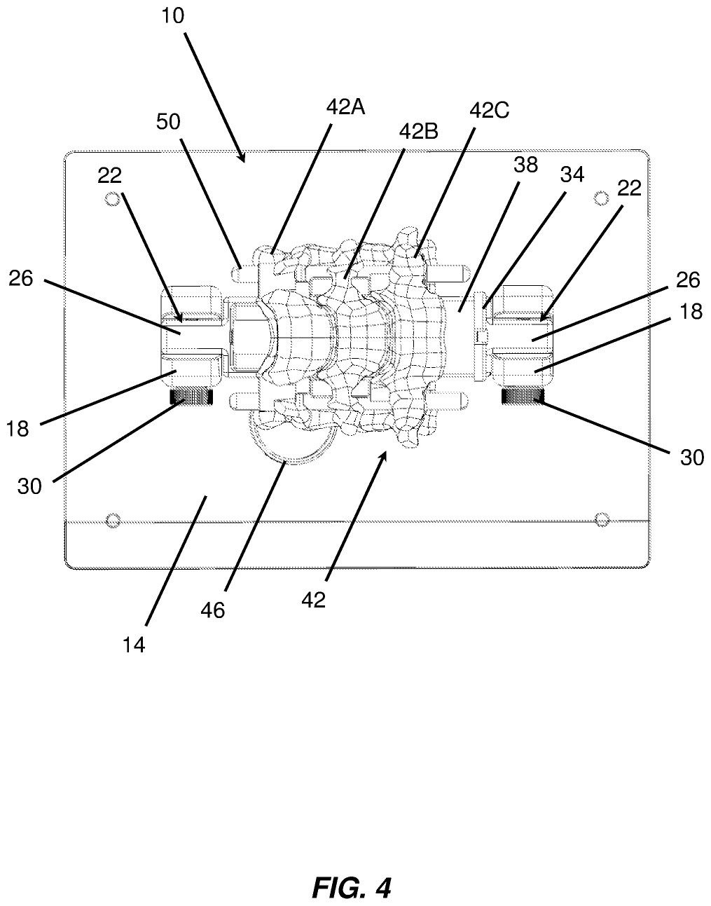

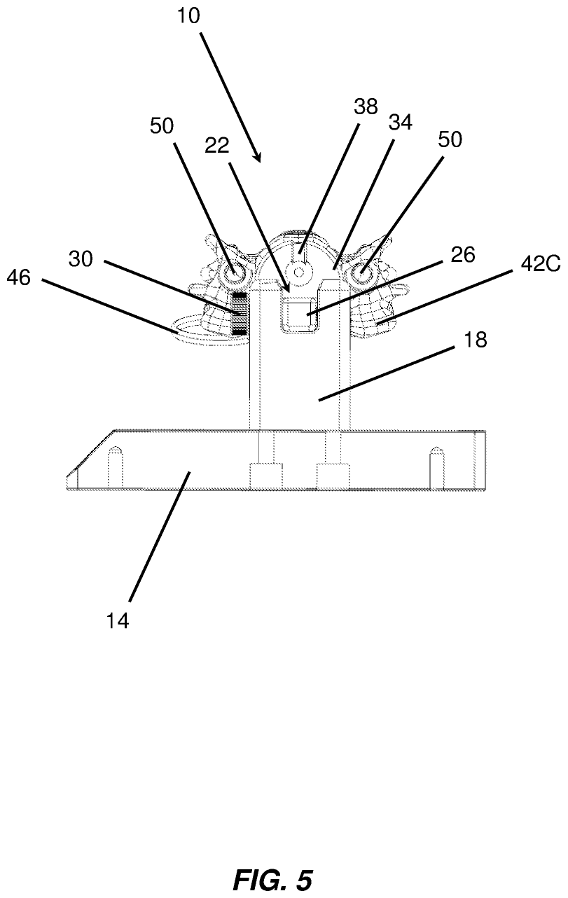

FIGS. 1 through 5 show drawings of the surgical training system. FIGS. 1 and 2 show perspective views of the spinal training system. FIG. 3 shows a side view of the spinal training system. FIG. 4 shows a top view of the spinal training system. FIG. 5 shows an end view of the spinal training system. In discussing the training system, some component details are not numbered in some of the drawings in order to not obscure the other details or the overall structure. The spinal training system 10 includes a base 14. The base 14 supports other components of the spinal training system 10 and holds these components during use of the training system. The base 14 may include feet or mounts such as posts or recesses which secure the base on a desk or bench and hold the base 14 securely during use. First and second risers 18 are attached to the base 14 and extend upwardly from the base 14. The risers 18 may be rectangular in shape and may extend vertically from the base. The risers 18 are typically fastened or bonded to the base 14.

The tops of the risers 18 may have a recess 22. The recesses 22 on the first and second risers are oriented along a common line to allow a carrier 26 to rest in the recesses 22. The recesses 22 have a faceted cross-sectional shape which is complementary to a faceted cross-sectional shape of the ends of the carrier 26 to thereby inhibit rotation of the carrier 26 while it is positioned in the recesses 22. In the example training system 10, the recesses 22 have a square cross-sectional profile and the ends of the carrier 26 have a complementary square cross-sectional profile. A fastener such as a thumbscrew 26 may be inserted into each riser 22 to thereby secure the carrier 26 into the riser. In the example training system, the thumbscrews 30 are threaded into threaded holes in the risers 22 and engage the ends of the carrier 26 to hold the carrier 26 into the risers 22. The carrier 26 may be removed from the riser recesses 22, rotated along its long axis in 90 degree increments, and placed back into the recesses 22 to thereby selectively position the anterior side, posterior side, or lateral sides of the vertebra up. This allows a surgeon to simulate the patient position during a procedure.

The carrier 26 includes a retainer such as retention wall 34 disposed near one end of the carrier 26. The retention wall 34 is used in combination with a retention bumper 38 to hold vertebrae bone models (generally referred to simply as vertebrae) on the carrier 26 and to place the vertebrae under compression. The retention wall typically extends perpendicularly to the long axis of the carrier 26. Vertebrae 42 are loaded onto the carrier 26. The carrier 26 is typically used to hold a series of two or more vertebrae 42. In the illustrated example, the vertebrae 42 include a C4 vertebrae 42A, a C5 vertebrae 42B, and a C6 vertebrae 42C. A user may select a desired sequence of vertebrae 42 and load the vertebrae onto the carrier 26 for a desired training use. The vertebrae 42 are held on the carrier 26 by a locking pin 46. The locking pin 46 passes through an opening in one of the vertebrae and also through an opening in the carrier 26. The locking pin 46 is located adjacent a side of the carrier 26 opposite the retention wall 34. One vertebra 42A is held in place by the locking pin 46 and this end vertebra 42A pushes the other vertebrae 42B, 42C against the compression bumper 38 to thereby elastically compress the compression bumper 38 and place a compressive force on the vertebrae 42. In another example, the locking pin 46 may be positioned outside of the vertebrae 42 (e.g. to the left of vertebrae 42A) so that the locking pin 46 passes through the carrier 26 but not through the vertebrae 42A and holds the vertebrae 42A, 42B, 42C against the compression bumper 38.

The vertebrae 42 are also held in compression by two tension ties 50 which pass through the vertebrae 42. The tension ties 50 are independently secured to the vertebrae 42 and holds the vertebrae 42 together independent of the carrier 26. The series of vertebrae 42 may be provided to a user with the tension ties 50 already installed so the user may simply place the stack of vertebrae onto the carrier 26 and place the locking pin 46 through the vertebrae 42A and/or carrier 26 to secure the vertebrae 42 on the carrier 26. The user may select a desired sequence of vertebrae according to their need for education or training. The sequence of vertebrae 42 may be selected to match the vertebral levels involved in a patient surgery, for example. In the position shown, the spinal training system 10 is ready for use. If a surgeon desires to practice installation of an artificial disc, for example, the surgeon will typically cut and prepare the vertebral bodies between two adjacent vertebrae to receive the disc and then install the disc between the prepared vertebrae 42. The vertebrae are formed with a more dense exterior shell and a more porous interior to match typical bone characteristics and provide a realistic surgical experience. The vertebrae 42 are held under compression and require the surgeon to use surgical tools to separate or position the vertebrae and require the surgeon to work under the constraints of the surrounding vertebrae. If desired, additional anatomical features such as major blood vessels or nerves may be attached to or part of the vertebrae to provide further realism to the surgeon. After installation of the disc, the surgeon may remove the stack of vertebrae 42 from the carrier 26. The vertebrae 42 and disc are held together by the tension ties 50 and may be used by the surgeon to further analyze or demonstrate the surgical technique.

FIG. 3 shows a side view of the spinal training system 10. The carrier 26 is held in the risers 18 so that it is parallel to the base 14. The first vertebrae 42A in the series of vertebrae 42 may be formed with a retention boss and retention hole which receive the locking pin 46 to secure the vertebrae 42 onto the carrier 26. The compression bumper 38 may be compressed by a relatively large amount to accommodate different lengths of the stack of vertebrae 42. The stack of vertebrae 42 may be longer or shorter according to the particular sequence of vertebrae which are selected (lower vertebrae in the spinal column being larger) or according to a patient physiology choice (e.g. large or small vertebrae to simulate a large or small patient). The compression bumper 38 allows for this difference in the length of the vertebrae 42. Additionally, interchangeable thick and thin compression bumpers 38 may be provided if needed.

The spinal training system 10 is often used with the anterior sides of the vertebrae facing up as is shown in the drawings as this provides access to the vertebral bodies for surgeries such as disc replacement or spinal fusion. The carrier may be rotated to simulate a lateral approach or posterior approach as desired.

The top view drawing in FIG. 4 shows how two tension ties 50 are used. The two tension ties 50 are placed symmetrically on both sides of the vertebrae 42. The end view drawing in FIG. 5 shows how the two tension ties 50 are disposed laterally relative to the vertebral body of each vertebrae 42 and will hold the stack of vertebrae 42 together. Both the tension ties 50 and the compression bumper 38 place the series of vertebrae 42 in compression while on the carrier 26.

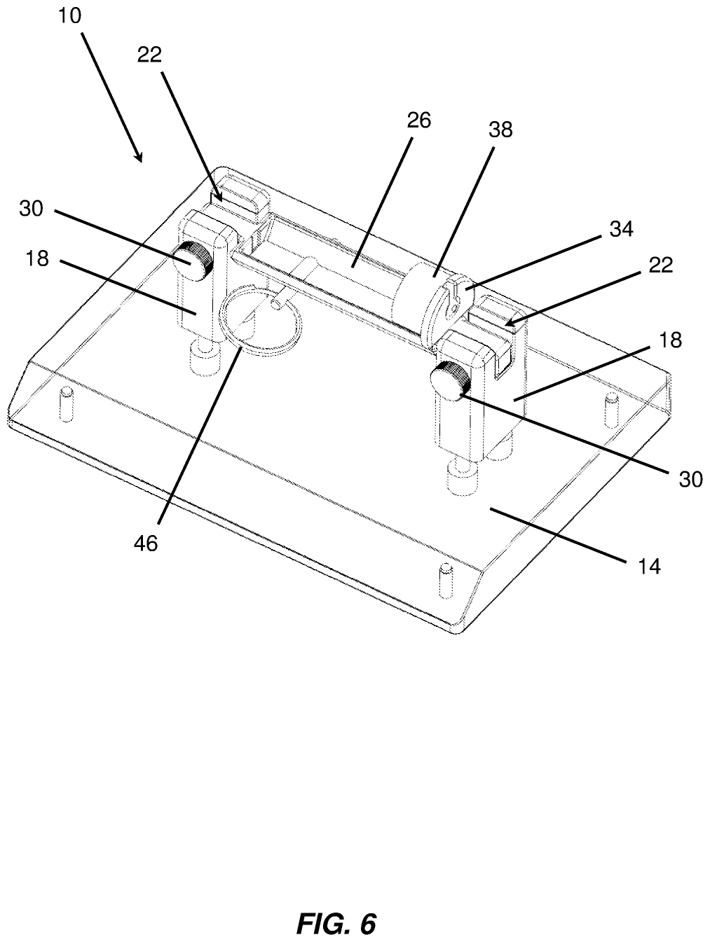

FIG. 6 shows a perspective drawing of the spinal training system 10 without showing the stack of vertebrae 42; better illustrating the support structures. The central body of the carrier 26 includes a trough with an open top and with a bottom wall and sidewalls. The carrier 26 includes a transverse hole or passage 54 which receives the locking pin 46 to hold the vertebrae 42 on the carrier. The retention wall 34 includes a keyhole shaped slot 58. The keyhole slot 58 includes a straight slot section which forms an opening in the top of the retention wall 34 and a connected enlarged retaining section. The compression bumper 38 includes a retaining post 62 which includes a stem and enlarged head. The retaining post 62 is placed into the keyhole slot 58 so that the enlarged head is located in the enlarged retaining section of the slot 58 to thereby secure the compression bumper to the retention wall 34. This attachment feature allows for replacement of the compression bumper 38 to changes sizes or to replace a damaged component.

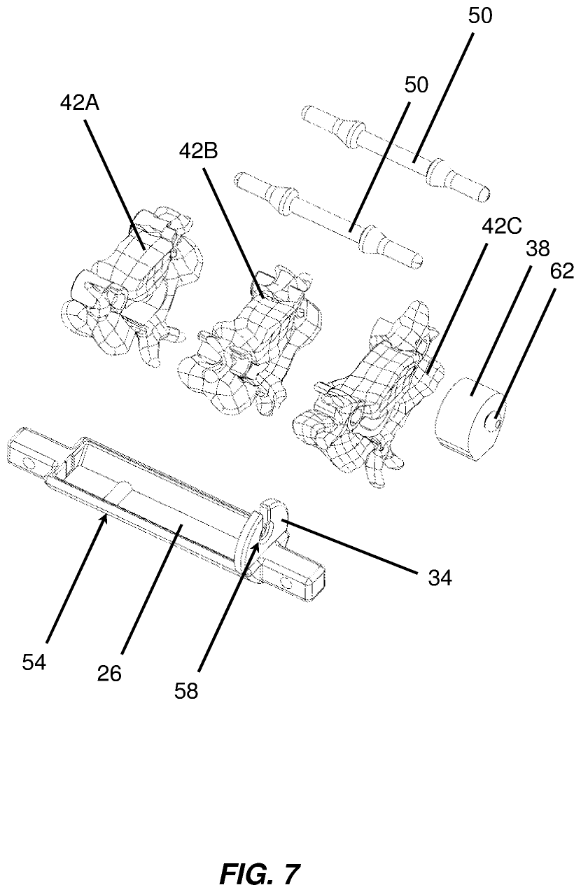

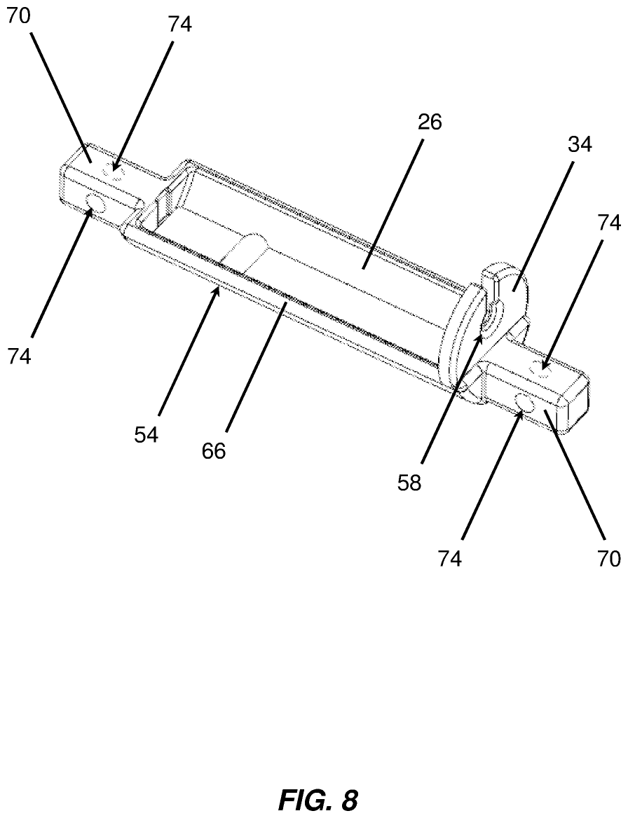

FIG. 7 shows an exploded perspective view of the carrier 26, compression bumper 38, vertebrae 42, and tension ties 50. FIGS. 8 through 11 show perspective drawings of the carrier, compression bumper, tension ties, and vertebrae. As shown in FIG. 8, the carrier 26 includes a center portion 66 which carries the vertebrae 42. The center portion 66 includes side walls which slope inwardly towards the bottom. The bottom of the center portion 66 is rounded. The top of the center portion 66 is open. The center portion 66 of the carrier 26 has a triangular cross-sectional shape with a rounded bottom. Two end posts 70 extend from the center portion 66. The ends 70 have square cross-sectional shapes to allow the carrier 26 to be rotated by 90 degree increments in the riser recesses 22. Additionally, the two ends 70 may be formed with holes 74 which extend through the ends 70 in a direction which is perpendicular to the long axis of the carrier 26. These holes 74 receive the fasteners 30 to secure the carrier 26 in the riser recesses 22. While one set of horizontally oriented holes 74 is shown, the carrier ends 70 may also have a second set of vertically oriented holes so that the fasteners 30 pass through the holes 74 in each orientation of the carrier 26 in the recesses 22. The fasteners 30 may be threaded screws and may engage female threads in the risers 18 or female threads in the carrier 26. Alternately, the fasteners 30 may be pins which pass through the risers 18 and the carrier 26.

The retention wall 34 extends upwardly from center portion 66 of the carrier 26 adjacent the location where the center portion 66 and the end post 70 meet. The retention wall 34 is generally circular in shape. Viewed from the end of the carrier 26, the retention wall 34 and the center portion 66 together are roughly circular in shape. The compression bumper 38 extends downwardly into the open top of the center portion 66 when it is installed against the retention wall 34. The locking pin hole 54 extends transversely through the center portion 66 of the carrier 26. As shown, a small bump in the center portion trough is formed around the locking pin hole 54 to enclose the locking pin hole 54. The carrier 26 may be formed from a rigid thermoplastic or a cast material such as a hard urethane. The example carrier 26 is clear to allow for observation of the vertebrae 42.

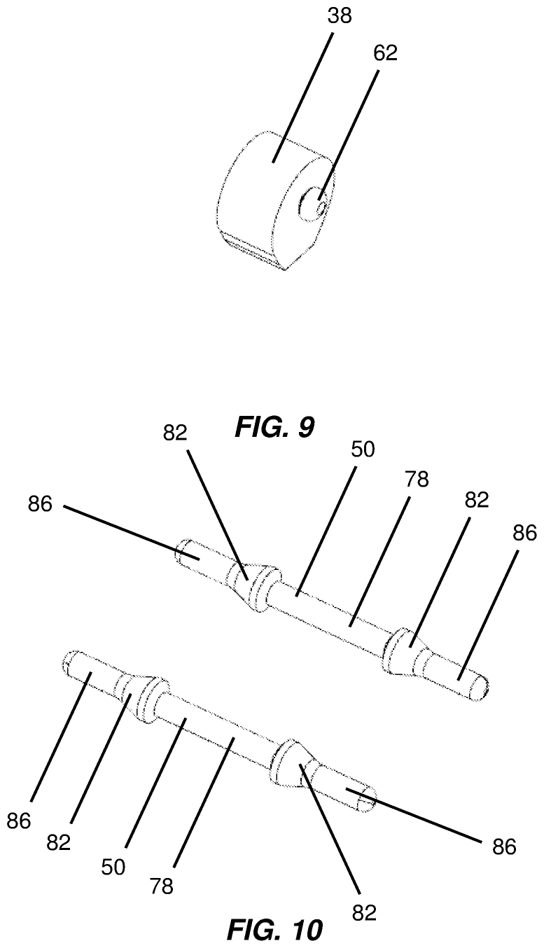

FIG. 9 shows the compression bumper 38. The compression bumper 38 is formed from an elastomeric material such as a rubber, silicone, or urethane and may be formed from an elastomeric foam. The compression bumper 38 includes a retaining post 62 which engages the retention wall 34 to secure the compression bumper 38 to the carrier 26. The retaining post 62 includes a short cylindrical neck and a rounded head extending from an end of the compression bumper 38. The neck of the retaining post 62 is inserted into the first, straight portion of the retention wall slot 58 and moved towards the enlarge portion of the slot 58 to allow the retaining post head to nest within the slot 58; securing the compression bumper 38 to the retention wall 34. In the example, the retention bumper 38 can compress and reduce in thickness by up to about 50 percent when engaged by the vertebrae 42. When compressed, the compression bumper 38 is compressed elastically and exerts a force against the vertebrae.

FIG. 10 shows the tension ties 50. The example tension ties 50 include a cylindrical body 78, conical locking members 82, and cylindrical ends 86. The conical locking members 82 are coaxial with the cylindrical body 78 and ends 86 and are oriented to provide a gradually sloped conical shape towards the ends 86 and a retention wall towards the center of the cylindrical body 78. The example tension ties 50 are made from an elastomeric material such as rubber, silicone, or urethane. The tension tie 50 is preferably capable of stretching to a length which is approximately double its original length. The example tension ties 50 are red in color.

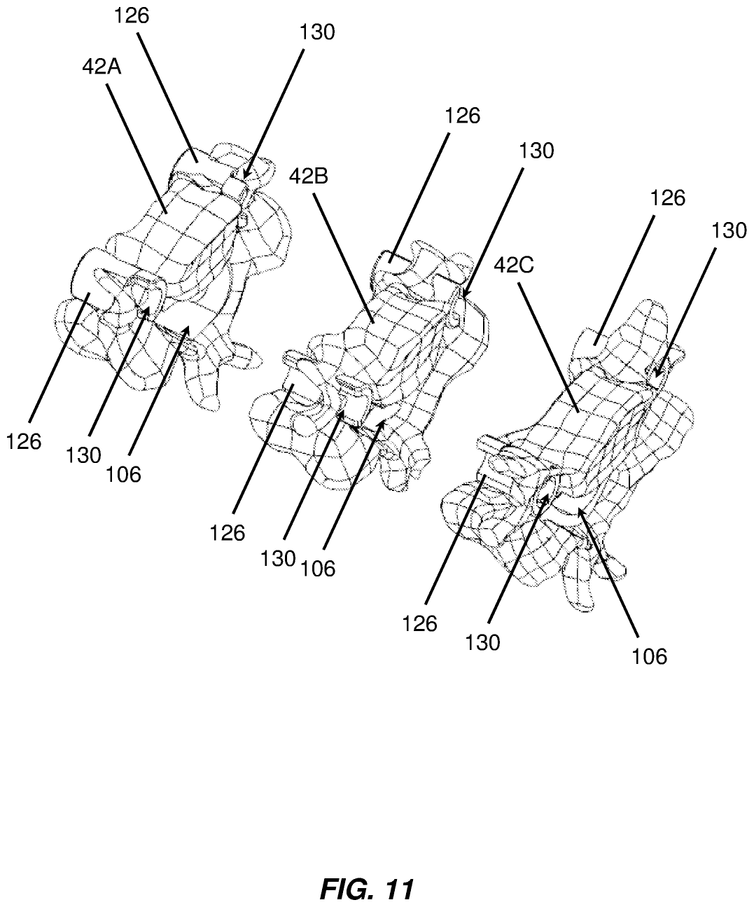

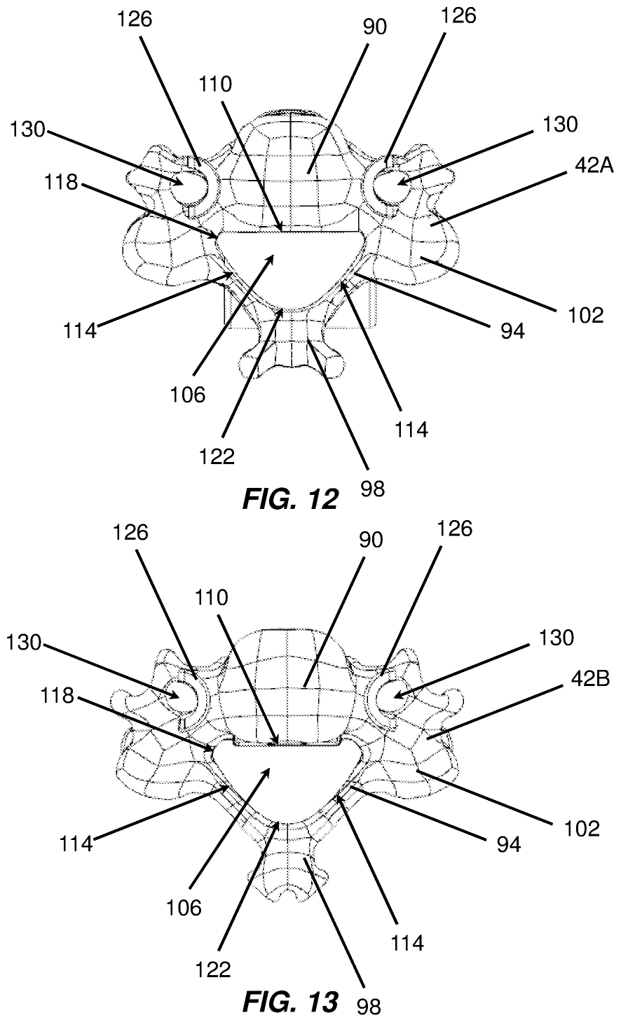

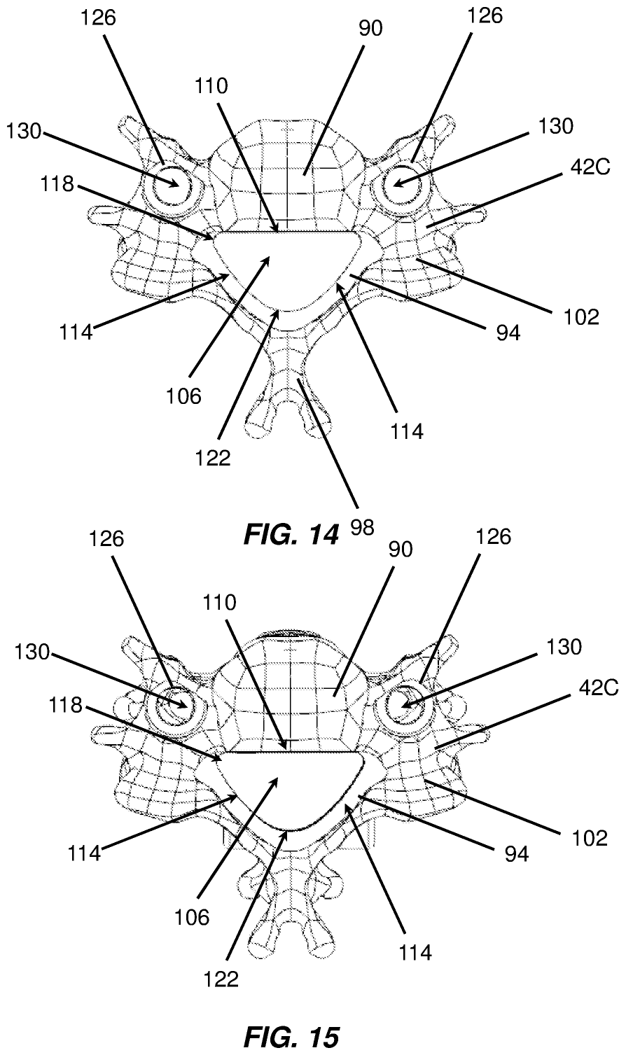

FIG. 11 shows a perspective view of the vertebrae 42. FIGS. 12 through 14 show end views of the individual vertebrae 42. The vertebrae 42 are anatomically correct models of human vertebrae except for the structural modifications described. Each vertebra 42 is formed with a vertebral body 90, lamina 94, spinous process 98, facet 102, etc. For each vertebrae 42A, 42B, 42C the anatomical vertebral foramen is replaced with a carrier channel 106. The carrier channel 106 is uniform in shape and is uniform between the various vertebrae 42 used with the spinal training system 10. The carrier channel 106 includes a flat anterior side 110 disposed adjacent the vertebral body 90. The flat anterior side 110 is connected to lateral sides 114 by curved anterior corners 118. The lateral sides 114 are gently curved; particularly on the posterior side of the vertebrae 42. The lateral sides 114 are connected to each other by a curved posterior corner 122. The posterior corner 122 is broadly curved with a larger radius while the anterior corners 118 are more tightly curved with a smaller radius. Each of the anterior side 110, lateral sides 114, anterior corners 118, and posterior corner 122 extend longitudinally (along the spinal column) through the vertebrae 42 to form a channel through the vertebrae 42 with the shape described. The carrier channel 106 is symmetrical left to right and is smoothly and uniformly shaped. For each vertebra 42, the carrier channel 106 is of a consistent size and shape regardless of the size or location of the anatomical vertebrae. For some vertebrae 42, the carrier channel 106 may be larger than the anatomical vertebral foramen. For other vertebrae 42, the carrier channel 106 may be smaller than the anatomical vertebral foramen. The carrier channel 106 allows a sequence of anatomical vertebrae 42 to be placed easily, consistently, and securely onto a carrier 26 and allows the vertebrae 42 and carrier 26 to replicate the anatomical spine for training and education. The vertebrae 42 are held stably while they are cut and while hardware is installed to replicate a surgery.

For each vertebrae 42A, 42B, 42C, the anatomical transverse foramen is replaced with a spacing boss 126. Each spacing boss 126 includes a cylindrical boss 126 and a tension hole 130. The spacing boss 126 and tension hole 130 extend longitudinally through the vertebrae 42 near the anatomical transverse foramen. The spacing boss 126 and tension hole 130 are placed consistently relative to the carrier channel 106. For some vertebrae, the spacing boss 126 and tension hole 130 may be closer to center or farther away from center and may also be shifted anteriorly or posteriorly relative to the anatomical transverse foramen. The tension hole 130 is a round hole which is larger in diameter than the tension rod central body 78 or ends 86 and is smaller in diameter than the conical locking members 82. The tension ties 50 are placed through the tension holes 130. Pulling on the end 86 of the tension tie 50 pulls the locking member 82 through the tension hole 130 so that the central body 78 of the tension tie is disposed in the tension hole 130. The shape of the locking members 82 makes it easier to install the tension ties 50 in the vertebrae 42 than to remove them from the vertebrae 42.

FIG. 11 illustrates how the spacing boss 126 is positioned longitudinally on the vertebrae and how the spacing boss 126 may vary in shape depending on its location on a vertebra 42. The spacing bosses 126 extend longitudinally from both sides of the vertebrae 42 (both superiorly and inferiorly relative to a standing person). Each spacing boss 126 has a first section which extends from the superior end of the vertebrae 42 and a second section which extends from the inferior end of the vertebrae 42. Where a section of a spacing boss 126 extends from a vertebrae 42 and is located between two adjacent vertebrae (e.g. between vertebrae 42A and vertebrae 42B) the spacing boss 126 is cut away along its longitudinal axis so that this section of the spacing boss 126 is a half cylindrical shell positioned on the medial side of the tension hole 130. Sections of a spacing boss 126 disposed on the outer ends of the stack of vertebrae 42 are cylindrical shells surrounding the tension hole 130 while sections of a spacing boss 126 between adjacent vertebrae 42 are partial cylindrical shells positioned on the medial side of the tension hole 130 and are open on the lateral side of the tension hole 130.

The spacing bosses 126 separate adjacent vertebrae 42 from each other. The spacing bosses 126 are of a length which allows adjacent spacing bosses 126 to contact each other when the vertebrae are placed adjacent each other. The spacing bosses 126 establish the spacing of the vertebrae along the carrier 26. FIG. 15 shows an end view of the vertebrae 42A, 42B, and 42C. When the vertebrae 42 are arranged for placement on the carrier 26, the carrier channels 106 and the tension holes 130 are lined up.

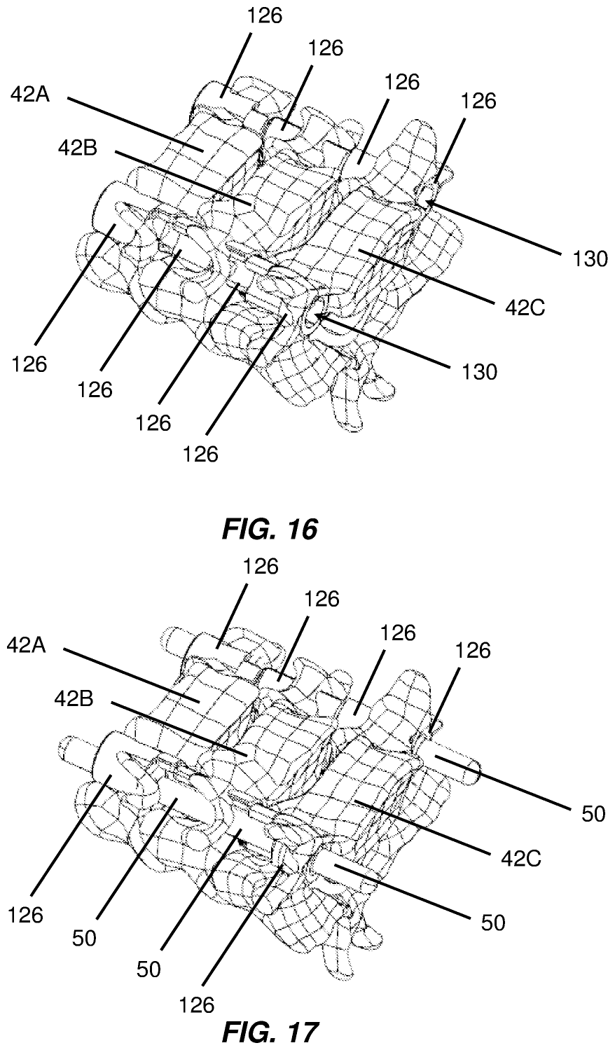

FIG. 16 shows the vertebrae 42A, 42B, and 42C disposed in alignment. It can be seen how the spacing bosses 126 contact each other between vertebrae and space the vertebrae 42 apart with the desired spacing. The spacing bosses 126 are oriented consistently between vertebrae 42 so that a continuous channel is made by the tension holes 130. FIG. 17 shows the vertebrae 42A, 42B, and 42C held together with tension ties 50. During assembly, the end 86 of a tension tie 50 is placed through a tension hole 130 on a vertebrae 42. The end 86 is then pulled until the locking member 82 is pulled through the tension hole 130. A second tension tie 50 is similarly installed onto the selected vertebrae 42. The adjacent vertebrae 42 are then similarly installed onto the tension ties 50 until all vertebrae 42 are held together by the tension ties 50. The series of vertebrae 42 may be provided to users in this assembled form. The user then places the assembled vertebrae 42 and tension ties 50 onto a carrier 26, pushes the vertebrae 42 against the compression bumper 38, and installs the locking pin 46. The spinal training system 10 is then ready for use.

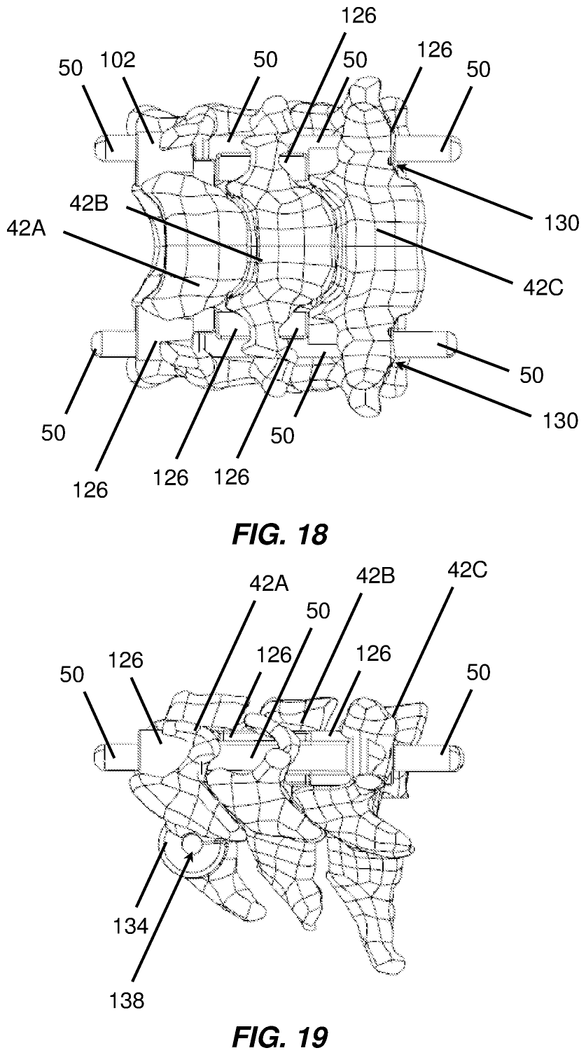

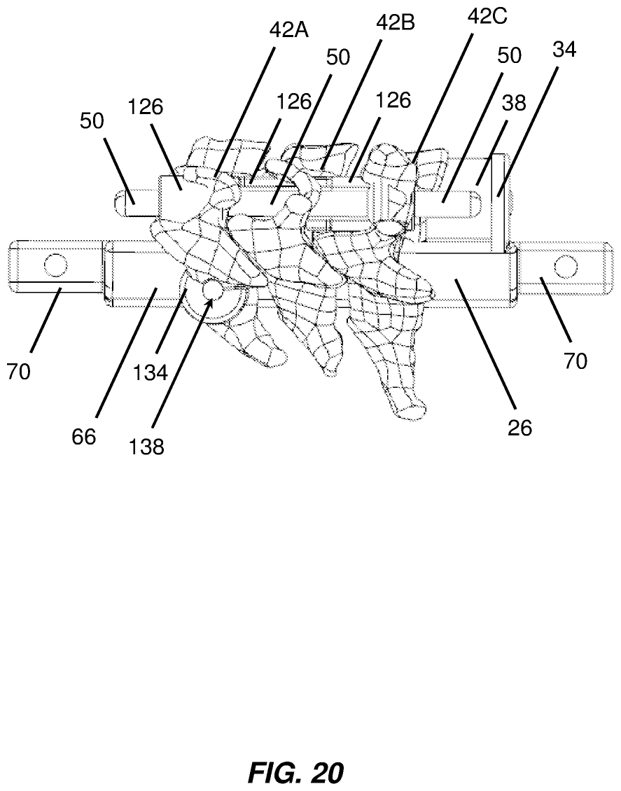

FIG. 18 shows a top view of the assembled vertebrae 42 and tension ties 50. The tension ties generally occupy the space of blood vessels passing through the transverse foramen in a patient and cause a user to consider these blood vessels while practicing a surgery or otherwise using the spinal training system 10. FIG. 19 shows a side view of the assembled vertebrae 42 and tension ties 50. FIG. 19 better illustrates the retention boss 134 and retention hole 138 formed in the vertebrae 42A. FIG. 20 shows a similar side view with the vertebrae 42 placed onto the carrier 26, illustrating how the retention hole 138 is aligned with the locking pin hole 54 formed in the carrier. The locking pin 46 passes through the vertebrae 42A and carrier 26.

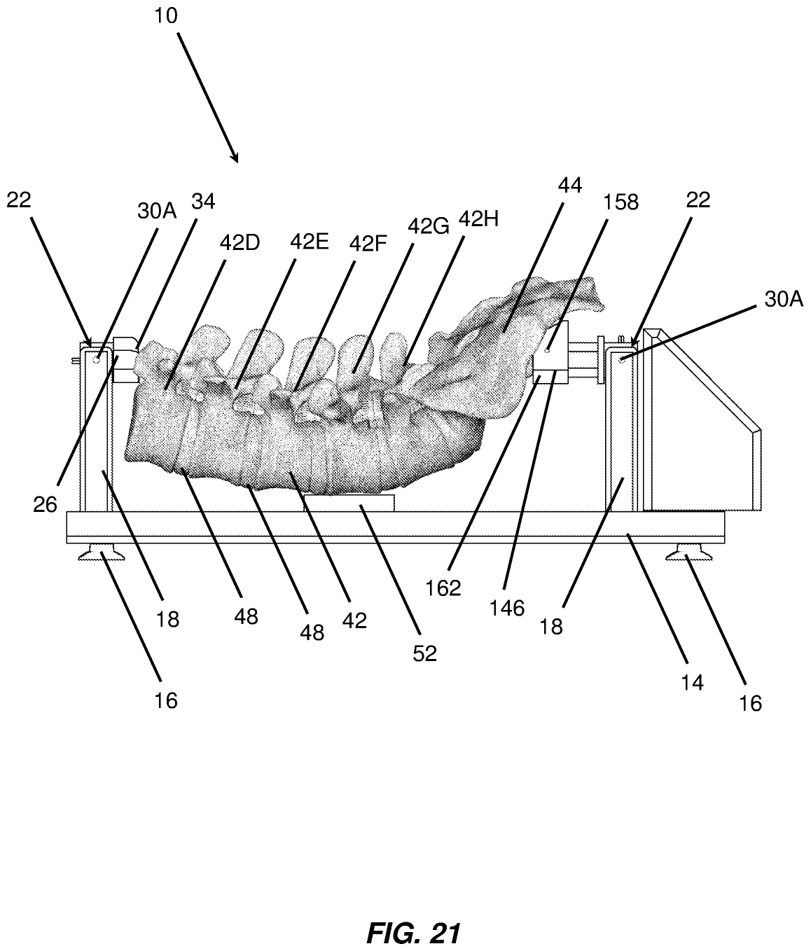

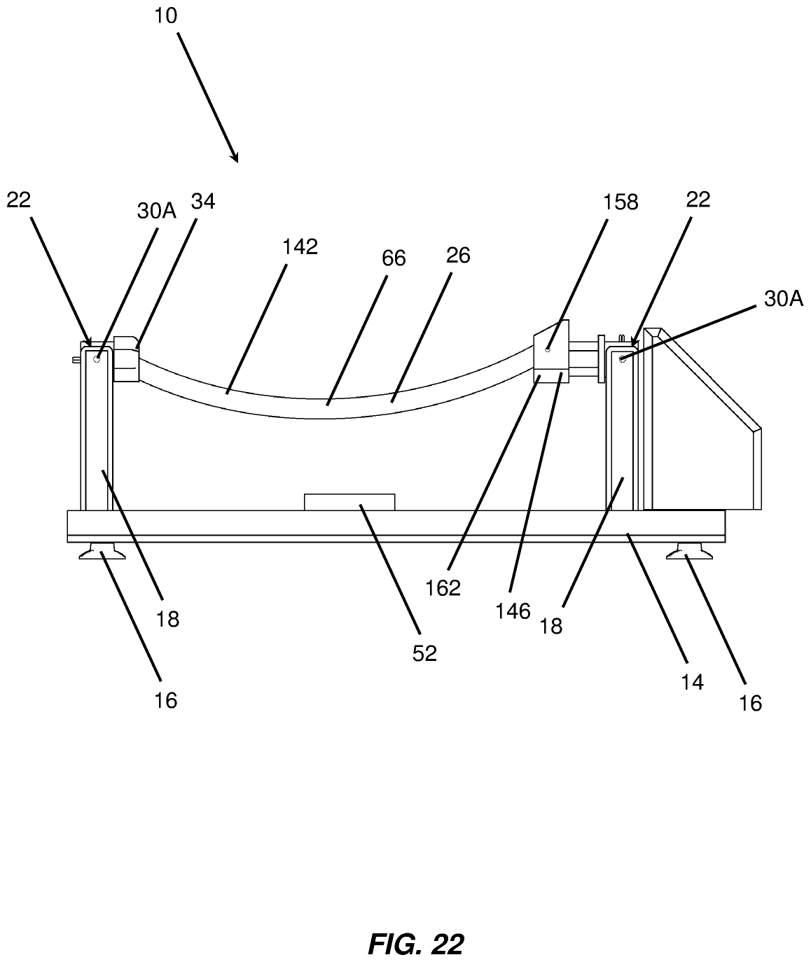

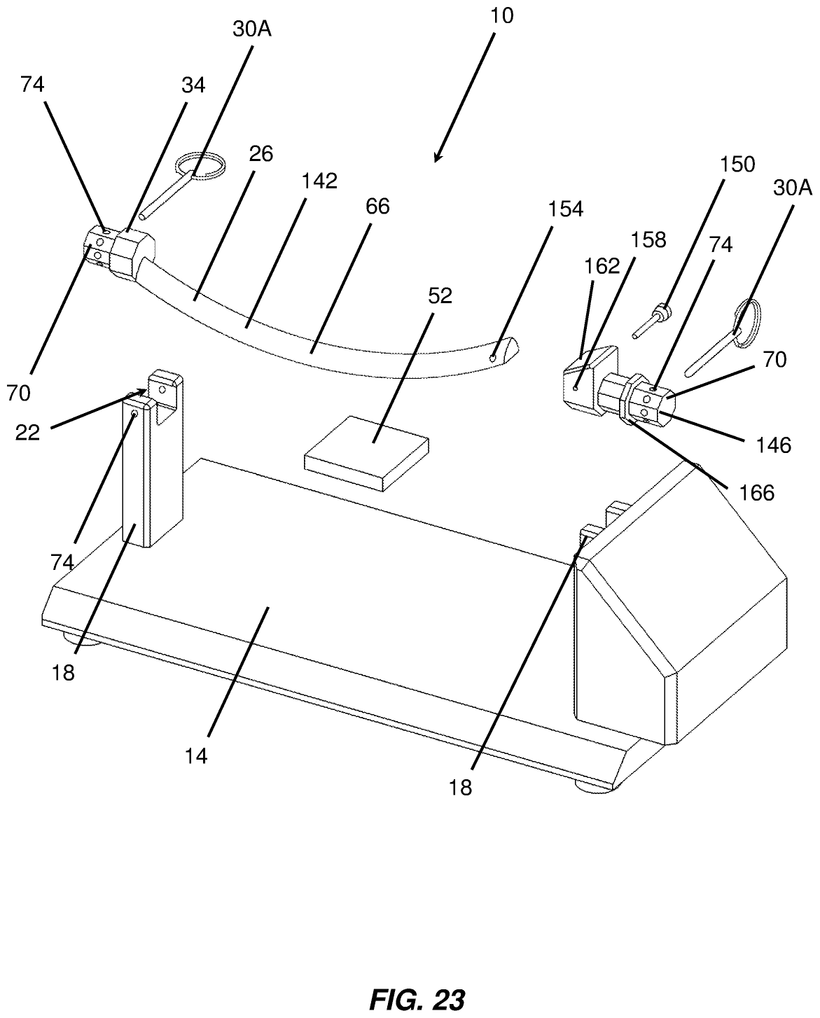

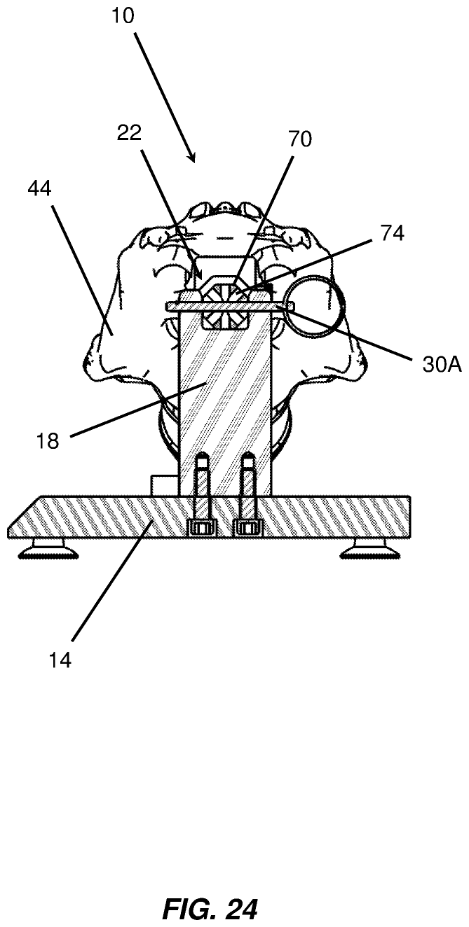

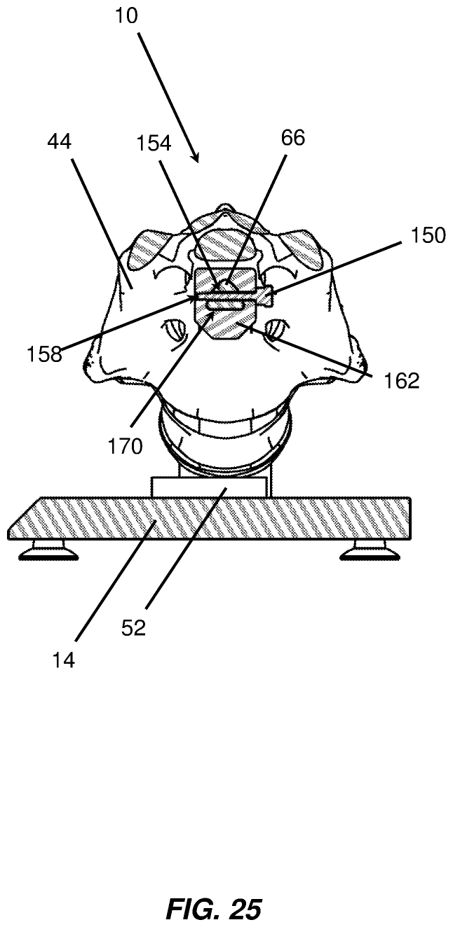

FIGS. 21 through 30 show a lumbar spinal straining system. The lumbar training system shares many features with the spinal training system shown in FIGS. 1 through 20. Unless otherwise specified, the lumbar spinal training system shown in FIGS. 21 through 30 contains all of the features and functionality of the spinal training system of FIGS. 1 through 20. FIG. 21 shows a side view of a lumbar spinal training system. FIG. 22 shows a side view of the lumbar spinal training system support frame. FIG. 23 shows an exploded view of the lumbar spinal training system support frame. FIG. 24 shows a cross-sectional view of the lumbar spinal training system. FIG. 25 shows a cross-sectional view of the lumbar spinal training system.

In discussing the training system, some component details are not numbered in some of the drawings in order to not obscure the other details or the overall structure. The spinal training system 10 includes a base 14. The base 14 supports other components of the spinal training system 10 and holds these components during use of the training system. The base 14 may include feet 16 or mounts such as posts or recesses which secure the base on a desk or bench and hold the base 14 securely during use. First and second risers 18 are attached to the base 14 and extend upwardly from the base 14. The risers 18 may be rectangular in shape and may extend vertically from the base 14. The risers 18 are typically fastened or bonded to the base 14.

The tops of the risers 18 may have a recess 22. The recesses 22 on the first and second risers 18 are oriented along a common line to allow a carrier 26 to rest in the recesses 22. The recesses 22 have a faceted cross-sectional shape which is complementary to a faceted cross-sectional shape of the ends of the carrier 26 to thereby inhibit rotation of the carrier 26 while it is positioned in the recesses 22. The ends of the carrier 26 may have a polygonal cross-sectional shape and the recesses 22 may have a complementary polygonal shape with an open top to allow the carrier 26 to be placed into the recesses 22 and to secure the carrier against rotation. In the example training system 10, the recesses 22 have an octagonal cross-sectional profile and the ends of the carrier 26 have a complementary square cross-sectional profile shape so that the carrier ends contact the bottom and sides of the recesses 22 and is held against rotation. A fastener such as a pin 30A may pass through a hole in both sides of each riser 22 and a hole in each end of the carrier 26 to thereby secure the carrier 26 into the riser. The carrier 26 may be removed from the riser recesses 22, rotated along its long axis in 45 degree increments, and placed back into the recesses 22 to thereby selectively position various sides of the vertebrae up. This allows a surgeon to simulate a desired patient position during a procedure.

The carrier 26 includes a retention wall 34 disposed near one end of the carrier 26. The retention wall 34 may be used in combination with a compression bumper 38 to hold vertebrae on the carrier 26 and to place the vertebrae under compression. The retention wall 34 typically extends generally perpendicular to the long axis of the carrier 26. Vertebrae 42 are loaded onto a center portion 66 of the carrier 26. The carrier 26 is typically used to hold a series of two or more vertebrae 42. In the illustrated example, the vertebrae 42 include L1 through L5 vertebrae (42D through 42H) and a sacrum 44. A user may select a desired sequence of vertebrae 42 and load the vertebrae onto the carrier 26 for a desired training use. The vertebrae 42 are held on the carrier 26 by a locking screw or pin 150 which passes through a hole in an end of the center portion 66 of the carrier 2 and a corresponding hole in a removable end section 146 of the carrier 26. The locking pin 150 passes through aligned openings in the center portion 66 of the carrier 26 and the end section 146 of the carrier. The locking pin 150 is located adjacent a side of the carrier 26 opposite the retention wall 34. The vertebrae 42D through 42H and sacrum 44 are held between the retention wall 34 and a similar retention wall or shoulder 36 on the removable end section 146 of the carrier 26. If desired, a compression bumper 38 may also be placed along the carrier center section 66, typically adjacent one of the end walls/shoulders 34, 36 to thereby elastically compress the compression bumper 38 and place a compressive force on the vertebrae 42 and sacrum 44.

The side view of the lumbar spinal training system 10 shows how the carrier 26 is held in the risers 18 so that its ends are parallel to the base 14. The center section 66 of the carrier 26 is curved so hold the vertebrae 42 in a curved orientation as shown. The vertebrae 42 have channels formed therethrough to receive the center portion 66 of the carrier. These carrier channels position the vertebrae on the carrier 26 and hold the vertebrae against significant movement during use.

The vertebrae 42 may be formed from elastomeric material such as urethane or a plastic, and may be formed with a more dense exterior shell and a more porous interior to match typical bone characteristics and provide a realistic surgical experience. Simulated discs 48 are positioned between the adjacent vertebral bodies. The simulated discs 48 may be formed from an elastomeric material such as rubber, silicone, or urethane, and may be foamed or have different center construction to provide a realistic experience. The discs 48 may be attached to the vertebrae 42 by adhesive, tabs/recesses, etc. The vertebrae 42 are held under compression by the carrier 26 and discs 48 and require the surgeon to use surgical tools to separate or position the vertebrae and require the surgeon to work under the constraints of the surrounding vertebrae similar to a surgical experience. If desired, additional anatomical features such as major blood vessels or nerves may be attached to or part of the vertebrae to provide further realism to the surgeon.

The stack of vertebrae 42 may be longer or shorter according to the particular number or sequence of vertebrae which are selected (lower vertebrae in the spinal column being larger) or according to a patient physiology choice (e.g. large or small vertebrae to simulate a large or small patient). A compression bumper 38 and/or a spacer which slides onto the carrier center section 66 allows for this difference in the length of the stack of vertebrae 42.

The lumbar spinal training system 10 is often used with the posterior sides of the vertebrae facing up as is shown in the drawings as this orientation may be commonly used during surgeries. The carrier may be rotated to simulate a lateral approach or anterior approach as desired. As the lumber spinal trainer 10 is often used with a longer carrier 26, a support block 52 may be placed between the base 14 and the vertebrae 42 to prevent excessive flexing of the carrier 26 during use. The example support block is a urethane rubber to allow for some flexing to replicate the movement that may occur during a surgery.

FIGS. 22 and 23 show a side view and an exploded perspective view of the lumbar spinal training system 10 without showing the vertebrae 42 to better illustrate the remaining structures. The carrier 26 includes a first carrier section 142 and a second carrier section 146. The free end of the carrier center section 66 is inserted into a complementarily shaped socket in the second carrier section 146 to connect the first carrier section 142 to the second carrier section 146. A fastener 150 such as a screw or pin is inserted through a hole 154 through the end of the center section 66 and a corresponding hole 158 in the second section 146 of the carrier 26. The central section 66 of the carrier 26 is curved to facilitate positioning multiple vertebrae in a natural state. Rather than following the shape of the natural spine, the central section 66 of the carrier 26 is formed with a modified curvature to facilitate positioning of vertebrae on the carrier 26. The central portion of the carrier 66 is formed with a uniform curve, such as a circular arc. The vertebrae 42 are also modified so that they are positioned correctly on such a modified carrier curve.

The cross-sectional shape of the center portion 66 is generally triangular with rounded corners. The upper edge of the center portion 66 is rounded and the side walls slope outwardly towards the bottom. The bottom of the center portion 66 is generally flat and there are rounded corners between the side walls and the bottom. Two ends 70 extend from the center portion 66. The ends 70 have octagonal cross-sectional shapes to allow the carrier 26 to be rotated by 45 degree increments in the riser recesses 22. The two ends 70 are formed with holes 74 which extend through the ends 70 in a direction which is perpendicular to the long axis of the carrier 26. The carrier ends 70 each have four holes positioned at 45 degree increments. There are holes 76 extending horizontally through the ends of the risers 18. Carrier holes 74 and riser holes 76 receive the fasteners 30A to secure the carrier 26 in the riser recesses 22. The fasteners 30A may alternatively be threaded screws and may engage female threaded holes in the risers 18 or female threaded holes in the carrier 26. As shown, the fasteners 30A pins which pass through the risers 18 and the carrier 26.

The retention wall 34 extends around the end of the first section 142 of the carrier 26 and separates the center portion 66 of the carrier 26 from the end post 70. The retention wall 34 may be octagonal in shape. The retention wall 34 forms a shoulder which contacts the riser 18 and secures the carrier 26 in position on the base. Additionally, vertebrae 42 abut the retention wall 34 in securing the vertebrae on the carrier 26. The center section 66 of the carrier extends from the retention wall 34. The second section 146 of the carrier 26 is removably attached to the first section of the carrier 142 by a socket and a fastener. The second section 146 includes a shoulder 162 formed on the end opposite the end post 70. The end of the shoulder 162 includes a socket to receive the end of the center section 66. The shoulder holds the vertebrae 42 and sacrum 44 on the center section 66. The shoulder 162 includes a hole 158 to receive a fastener 150 to secure the end of the center section 66 in the socket. If the shoulder 162 does not extend far enough to contact the riser 18, the second section 146 of the carrier may have a positioning ridge or shoulder 166 which contacts the riser 18 and keeps the carrier 26 in a desired position in the base 14. The carrier 26 may be formed from a rigid thermoplastic or a cast material such as a hard urethane. The carrier 26 may be clear to allow for observation of the vertebrae 42.

FIG. 24 shows a cross-section of the lumbar training system taken through the right side riser 18. This drawing particularly illustrates how the end posts 70 have an octagonal cross-section and four transverse holes 74 and allow the carrier 26 to be secured into the riser channel 22 at different rotational positions. The carrier 26 is held securely by both the fit of the end post 70 in the channel 22 and the fastener 30A.

FIG. 25 shows a cross-section of the lumbar training system taken through the joint between the first carrier section 142 and the second carrier section 146. The shoulder 162 of the inward facing end of the second carrier section 146 includes a socket 170 which is sized and shaped to receive the free end of the carrier center section 66 and hold the center section 66 securely without significant play. A fastener 150 passes through a hole 154 in the center section 66 and a hole 158 in the shoulder 162.

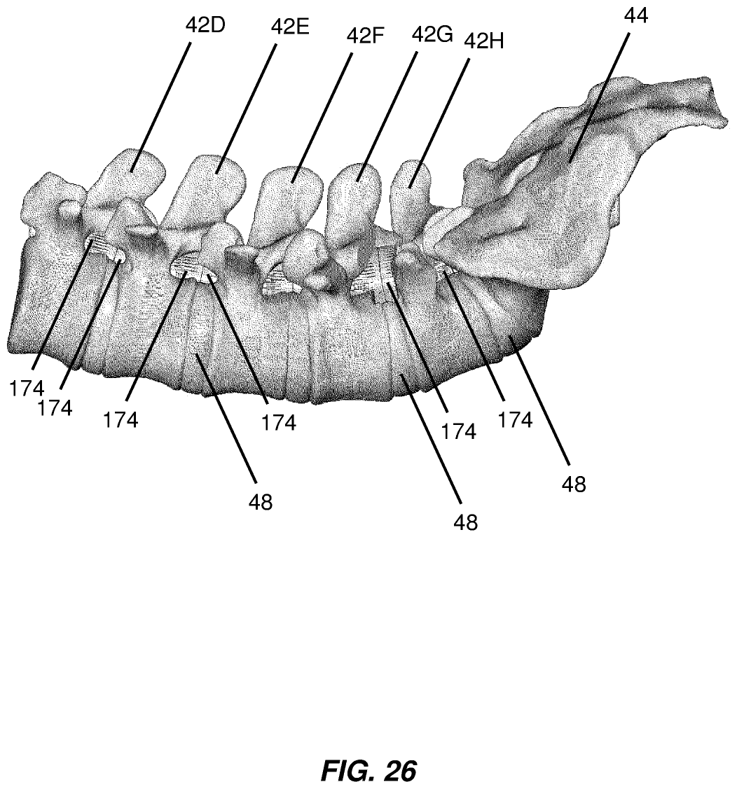

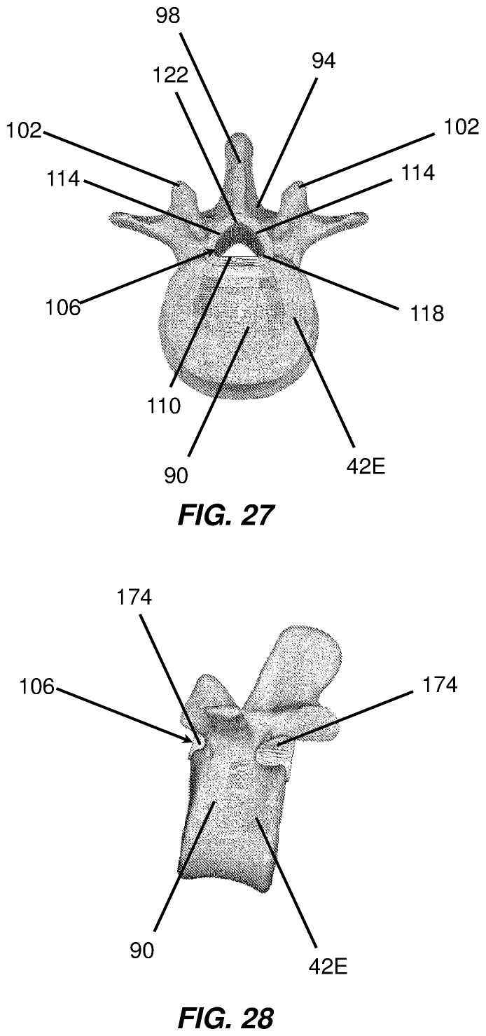

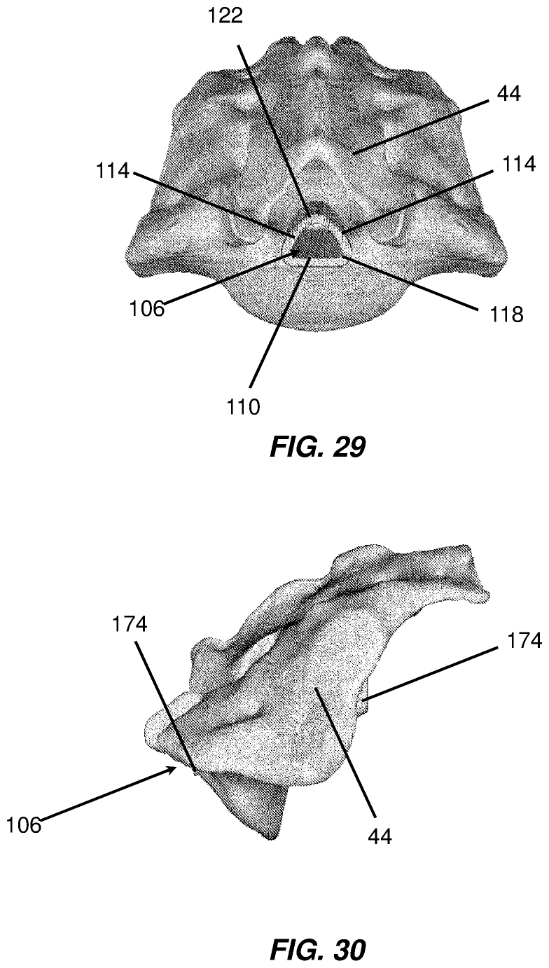

FIGS. 26 through 30 show the vertebrae 42 and sacrum 44 of the lumbar training system 10. FIG. 26 shows a side view of the L1 through L5 lumbar vertebrae and sacrum. FIG. 27 shows an end (superior) view of the L2 lumbar vertebrae. FIG. 28 shows a side view of the L2 lumbar vertebrae. FIG. 29 shows an end (superior) view of the sacrum. FIG. 30 shows a side view of the sacrum.

The vertebrae 42 and sacrum 44 are anatomically correct models of human vertebrae and sacrum except for the structural modifications described. Each vertebra 42 is formed with a vertebral body 90, lamina 94, spinous process 98, facet 102, etc. For each vertebra 42D through 42H the anatomical vertebral foramen is replaced with a carrier channel 106. The carrier channel 106 is uniform in shape and is uniform between the various vertebrae 42 used with the spinal training system 10. The carrier channel 106 has a generally triangular cross-sectional shape with rounded corners. The carrier channel 106 includes a flat anterior side 110 disposed adjacent the vertebral body 90. The flat anterior side 110 is connected to lateral sides 114 by curved anterior corners 118. The lateral sides 114 are curved with a larger radius of curvature than the corners 118, 122. The lateral sides 114 are connected to each other by a curved posterior corner 122. Each of the anterior side 110, lateral sides 114, anterior corners 118, and posterior corner 122 extend longitudinally (along the spinal column) through the vertebrae 42 to form a channel through the vertebrae 42 with the shape described. The carrier channel 106 is symmetrical left to right and is smoothly and uniformly shaped. For each vertebra 42, the carrier channel 106 is of a consistent size and shape regardless of the size or location of the anatomical vertebrae.

The example center section 66 of the carrier 26 has a uniform profile along its length. Where the natural spinal cord is of varying shape and size along its length, the carrier center section 66 is a uniform size and shape. The vertebrae carrier channel 106 is not positioned strictly at the vertebral foramen, but is varied in its position and size to accommodate the carrier center section 66 and place the vertebrae in an anatomically correct position when mounted on the carrier 26. For some vertebrae 42, the carrier channel 106 may be larger than the anatomical vertebral foramen. For other vertebrae 42, the carrier channel 106 may be smaller than the anatomical vertebral foramen. The carrier channel 106 allows a sequence of anatomical vertebrae 42 to be placed easily, consistently, and securely onto a carrier 26 and allows the vertebrae 42 and carrier 26 to replicate the anatomical spine for training and education. The vertebrae 42 are held stably while they are cut and while hardware is installed to replicate a surgery.

For lumber vertebrae 42, transverse foramen is replaced with a carrier channel 106 and also extended with a spacing boss 174. Each spacing boss 174 includes a tubular extension of the carrier channel 106. The spacing boss 174 extends generally longitudinally from the vertebrae 42 near the anatomical vertebral foramen. The example spacing bosses 174 are formed with a uniform exterior shape that parallels the shape of the carrier channel 106. For some vertebrae, the spacing boss 174 and carrier channel 106 may be shifted anteriorly or posteriorly relative to the anatomical vertebral body and vertebral foramen.

The spacing bosses 174 extend longitudinally from both sides of the vertebrae 42 (both superiorly and inferiorly relative to a standing person). Each spacing boss 174 has a first section which extends from the superior end of the vertebrae 42 and a second section which extends from the inferior end of the vertebrae 42. The spacing bosses 174 extend from the vertebrae 42 and contact spacing bosses 174 on adjacent vertebrae to separate adjacent vertebrae 42 from each other and place the vertebrae in a desired spacing and alignment. The spacing bosses 174 are of a length which allows adjacent spacing bosses 126 to contact each other when the vertebrae are placed adjacent each other. The spacing bosses 126 establish the spacing of the vertebrae along the carrier 26 and also establish the thickness of the simulated discs 48 and the amount of pressure placed on the discs 48 by the adjacent vertebrae.

The sacrum 44 is also formed with a carrier channel 106. The carrier channel 106 is uniform in shape and is positioned in the sacrum 44 in a position which deviates from the position of the spinal cord and nerves in the sacrum. The carrier channel 106 in the sacrum is positioned to continue the curved pathway through the vertebrae 42 to align the sacrum with the vertebrae 42 once installed on the carrier 26. The carrier channel 106 exits the lower anterior face of the sacrum 44.

The carrier channel 106 has a generally triangular cross-sectional shape with rounded corners. The carrier channel 106 includes a flat anterior side 110 disposed adjacent the vertebral body 90. The flat anterior side 110 is connected to lateral sides 114 by curved anterior corners 118. The lateral sides 114 are curved with a larger radius of curvature than the corners 118, 122. The lateral sides 114 are connected to each other by a curved posterior corner 122. Each of the anterior side 110, lateral sides 114, anterior corners 118, and posterior corner 122 extend longitudinally (along the spinal column) through the vertebrae 42 to form a channel through the vertebrae 42 with the shape described. The carrier channel 106 is symmetrical left to right and is smoothly and uniformly shaped. The carrier channel 106 is of a consistent size and shape with the carrier channel 106 through the vertebra 42 and deviates significantly from the location of nerve tissue in the anatomical sacrum.

The sacrum carrier channel 106 is also extended with a spacing boss 174. Each spacing boss 174 includes a tubular extension of the carrier channel 106. The spacing boss 174 on the superior end of the sacrum 44 will contact the spacing boss on a vertebra 42. The spacing boss 174 on the inferior/anterior face of the sacrum contacts the shoulder 162 on the carrier 26. In the example training system, the carrier channels 106 form a continuous channel through the vertebrae 42 and sacrum 44 and the spacing bosses 174 form a continuous tube profile through the vertebrae 42 and sacrum 44. Sleeves or elastomeric compression bumpers may be placed between the vertebrae 42, sacrum 44, or the retention walls 34, 162 to modify the spacing or compression on the vertebrae 42. A sleeve may be placed on the carrier 26 to replace a vertebra 42 which is not necessary for a training scenario.

The simulated discs 48 as well as the vertebrae 42 may be modified to simulate defect conditions in a patient. Discs 48 may be formed which are herniated or collapsed. Discs 48 or vertebrae 42 may be formed to present alignment defects. The vertebrae may be modified to include osteophytes or other bony defects. The discs 48 may attach to the vertebral bodies by posts/projections which engage corresponding recesses, and may also be attached with adhesive. The vertebrae 42 may include removable endplates or endplate sections which allow a user to add bone defects to the vertebrae. The endplates may be attached to the vertebrae with projections and corresponding recesses or rails/dovetails and corresponding channels. The endplate may commonly have the projection or rail and the vertebrae the corresponding recess. Such endplates may be installed with adhesive in addition to the mechanical retention and locating features.

The spinal training system 10 allows a user to practice surgical techniques on a realistically modeled spine. The vertebrae 42 are placed under compression and also allowed to shift during use by pressing against the compression bumper 38 and tension ties 50. This allows a user to use tools such as surgical spreaders and positioning tools; increasing the realism of the training system 10.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, voltages, currents, frequencies, power range values, times, etc., are provided for explanation purposes and that other values may also be employed in other examples in accordance with the teachings of the present invention.

What is claimed is:

1. A spinal surgical training system comprising:
a base;
an elongate carrier having a first end and a second end and a center section located between the first end and the second end, wherein the first end and the second end are held by the base to support the carrier;
wherein the center section comprises an elongate uniform profile;
a first model vertebra removably disposed on the carrier center section, the first model vertebra comprising a carrier channel formed in place of a vertebral foramen and a spacing boss extending from the first model vertebra;
a second model vertebra removably disposed on the carrier center section, the second model vertebra comprising a carrier channel formed in place of a vertebral foramen and a spacing boss extending from the second model vertebra;
wherein the first spacing boss contacts the second spacing boss to position the first vertebrae relative to the second vertebrae.

2. The system of claim 1, further comprising a third model vertebra removably disposed on the carrier center section, the third model vertebra comprising a carrier channel formed in place of a vertebral foramen, wherein the first vertebra, second vertebra, and third vertebra are models of sequential vertebrae in a human spine, and wherein the first vertebra carrier channel, second vertebra carrier channel, and third vertebra carrier channel comprise a single cross-sectional size and shape.

3. The system of claim 1, wherein the first carrier channel and the second carrier channel comprise a triangular cross-sectional shape.

4. The system of claim 1, wherein the first vertebra spacing boss comprises a tubular extension of the first carrier channel and extends from the first vertebra, and wherein the second vertebra spacing boss comprises a tubular extension of the second carrier channel and extends from the second vertebra.

5. The system of claim 1, wherein the carrier first end and the carrier second end comprise polygon cross-sections, and wherein the carrier may be positioned in a base first recess and a base second recess in different rotational orientations to thereby position the first and second vertebrae with a desired side facing up.

6. The system of claim 1, wherein the carrier comprises a retaining wall between the center portion and the first end, and wherein the first vertebra is held against the retaining wall and the second vertebra is held against the first vertebra by a fastener which passes through the carrier.

7. The system of claim 1, wherein the first vertebra comprises passages formed therethrough in place of transverse foramen, wherein the second vertebra comprises passages formed therethrough in place of transverse foramen, and further comprising elastic tension ties passing through the passages and holding the first vertebra to the second vertebra.

8. The system of claim 1, further comprising a model sacrum, wherein the first vertebra and the second vertebra comprises model lumbar vertebrae, and wherein the carrier center section comprises a uniform curve along its length, wherein the sacrum comprises a carrier channel passing therethrough, and wherein the first vertebra carrier channel, second vertebra carrier channel, and sacrum carrier channel are aligned along the uniform curve.

9. The system of claim 1, wherein the carrier comprises:
a first carrier section comprising the first end and the center section;
a second carrier section comprising the second end and a socket formed in an end of the second carrier section; and
wherein an end of the center section is inserted into the socket to thereby secure the first carrier section to the second carrier section and thereby prevent removal of the first vertebra and the second vertebra from the carrier.

10. A spinal surgical training system comprising:
a base;
an elongate carrier having a first end and a second end a center section located between the first end and the second end, and a retention wall located between the first end and the center section, wherein the first end and the second end are held by the base to support the carrier;
wherein the center section comprises an elongate uniform profile;
a compressible retention bumper disposed against the retention wall adjacent the center section;
a first model vertebra removably disposed on the carrier center section, the first model vertebra comprising a carrier channel formed in place of a vertebral foramen and a spacing boss extending from the first model vertebra;
a second model vertebra removably disposed on the carrier center section, the second model vertebra comprising a carrier channel formed in place of a vertebral foramen and a spacing boss extending from the second model vertebra; and
a fastener attached to the carrier and positioned to hold the second model vertebra against the first model vertebra and to hold the first model vertebra against the retention bumper and to hold the first vertebra and the second vertebra on the carrier.

11. The system of claim 10, wherein the first spacing boss contacts the second spacing boss to position the first vertebrae relative to the second vertebrae.

12. The system of claim 10, further comprising a third model vertebra removably disposed on the carrier center section, the third model vertebra comprising a carrier channel formed in place of a vertebral foramen, wherein the first vertebra, second vertebra, and third vertebra are models of sequential vertebrae in a human spine, and wherein the first vertebra carrier channel, second vertebra carrier channel, and third vertebra carrier channel comprise a single cross-sectional size and shape.

13. The system of claim 10, wherein the first vertebra comprises passages formed therethrough in place of transverse foramen, wherein the second vertebra comprises passages formed therethrough in place of transverse foramen, and further comprising elastic tension ties passing through the passages and holding the first vertebra to the second vertebra.

14. The system of claim 13, wherein the first vertebra spacing boss comprises a tubular extension of a passage and extends from the first vertebra, and wherein the second vertebra spacing boss comprises a tubular extension of a passage and extends from the second vertebra.

15. The system of claim 10, wherein the carrier first end and the carrier second end comprise polygon cross-sections, and wherein the carrier may be positioned in a base first recess and a base second recess in different rotational orientations to thereby position the first and second vertebrae with a desired side facing up.

16. A spinal surgical training system comprising:
a base;
an elongate carrier having a first end and a second end and a center section located between the first end and the second end, wherein the first end and the second end are held by the base to support the carrier;
wherein the center section comprises an elongate uniform profile which is curved longitudinally;
a first model vertebra removably disposed on the carrier center section, the first model vertebra comprising a carrier channel formed in place of a vertebral foramen and a spacing boss extending from the first model vertebra;
a second model vertebra removably disposed on the carrier center section, the second model vertebra comprising a carrier channel formed in place of a vertebral foramen and a spacing boss extending from the second model vertebra;
wherein the first spacing boss contacts the second spacing boss to position the first vertebrae relative to the second vertebrae.

17. The system of claim 16, further comprising a model sacrum, wherein the first vertebra and the second vertebra comprises model lumbar vertebrae, and wherein the carrier center section comprises a uniform curve along its length, wherein the sacrum comprises a carrier channel passing therethrough, and wherein the first vertebra carrier channel, second vertebra carrier channel, and sacrum carrier channel are aligned along the uniform curve.

18. The system of claim 16, wherein the carrier comprises:
a first carrier section comprising the first end, the center section, and a retaining wall located between the first end and the center section;
a second carrier section comprising the second end and a socket formed in an end of the second carrier section; and
wherein an end of the center section is inserted into the socket to thereby secure the first carrier section to the second carrier section and thereby secure the first vertebra and the second vertebra between the retaining wall and the second carrier section.

19. The system of claim 16, wherein the first vertebra spacing boss comprises a tubular extension of the first carrier channel and extends from the first vertebra, and wherein the second vertebra spacing boss comprises a tubular extension of the second carrier channel and extends from the second vertebra.

20. The system of claim 16, wherein the carrier first end and the carrier second end comprise polygon cross-sections, and wherein the carrier may be positioned in a base first recess and a base second recess in different rotational orientations to thereby position the first and second vertebrae with a desired side facing up.
